(19) United States
(12) Patent Application Publication
(10) Pub. No.: US 2026/0106377 A1
(43) Pub. Date: Apr. 16, 2026

(54) CIRCULARLY POLARIZED ANTENNA AND HEARING INSTRUMENT

(71) Applicant: Sivantos Pte. Ltd., Singapore (SG)

(72) Inventor: Hamed HASANI, Erlangen (DE)

(21) Appl. No.: 19/352,518

(22) Filed: Oct. 8, 2025

(30) Foreign Application Priority Data
Oct. 16, 2024 (DE) 10 2024 210 037.4

(51) Int. Cl. H01Q 9/04; H01Q 1/38; H04R 25/00

(52) U.S. Cl. CPC H01Q 9/0428; H01Q 1/38; H04R 25/554; H04R 2420/07

(57) ABSTRACT

A circularly polarized antenna for a hearing instrument has a ground layer and an exciter layer separated from the ground layer by a first dielectric layer, coupled to a signal port routed through the first dielectric layer and the ground layer. In addition, the antenna has a top layer arranged on the side of the exciter layer facing away from the ground layer and separated from the exciter layer by a second dielectric layer. The top layer is connected to the ground layer at four locations by interconnecting a respective capacitance and/or a respective inductance.

### CROSS-REFERENCE TO RELATED APPLICATION

This application claims the priority, under 35 U.S.C. § 119, of German Patent Application DE 10 2024 210 037.4, filed Oct. 16, 2024; the prior application is herewith incorporated by reference in its entirety.

### FIELD AND BACKGROUND OF THE INVENTION

The invention relates to a circularly polarized antenna. The invention further relates to a hearing instrument with such an antenna.

Hearing instruments (or also: hearing devices) usually are for outputting a sound signal to the hearing of the wearer of this hearing instrument. Outputting is performed using an output transducer, mostly acoustically via airborne sound using a loudspeaker (herein also referred to as an “earphone” or “receiver”). Such hearing instruments are often used as so-called hearing aid devices (also short: hearing aids). The hearing instruments typically comprise an acoustic input transducer (particularly a microphone) and a signal processor configured to process the input signal (also: microphone signal) generated from the ambient sound by the input transducer using at least one typically user-specific stored signal processing algorithm such that a hearing impairment of the wearer of the hearing instrument is at least partially compensated for. Particularly in the case of a hearing aid device, the output transducer, among being a loudspeaker, may alternatively also be a so-called bone conduction receiver or a cochlear implant configured to mechanically or electrically couple the sound signal into the wearer's hearing. In addition, there are hearing instruments which protect or improve the hearing ability of normal-hearing users, for example intended to enable improved speech comprehension in complex hearing situations. Such devices are also referred to as “personal sound amplification products” (short: PSAP). The term hearing instruments additionally includes specifically devices such as so-called tinnitus masker, headsets, headphones and the like.

Typical designs of hearing instruments, particularly hearing aids, are behind-the-ear (“BTE”) and in-the-ear (“ITE”) hearing instruments. These terms are directed at the intended wearing position. Behind-the-ears hearing instruments have a (main) housing which is worn behind the auricle. They can be distinguished in models the loudspeaker of which is arranged within this housing—the sound is usually output to the ear using a sound tube worn within the ear canal—and in models having an external loudspeaker being placed in the ear canal. In-the-ear hearing instruments, however, have a housing worn within the auricle or even entirely within the ear canal.

In addition, hearing instruments provide the possibility to select or make adjustments, in the most simple case at least to a volume value or also so-called hearing programs. Apart from operating via switches or buttons at the hearing instrument itself, which may be challenging due to particularly small designs, operating via a type of remote control is significantly more comfortable. Since a wired remote control may be noticeable or also unnerving due to an entwined connecting cable, a radio communication between remote control and hearing device is significantly more user-friendly. Using a smartphone with a corresponding installed application as a remote control is particularly interesting. For this, but also for coupling external audio signals (such as TV audio), radio communication based on the Bluetooth standard (“Bluetooth” is a registered trademark) is of interest. Due to minimal antenna dimensions, it is important to combine miniaturizing hearing instruments, particularly hearing instruments to be worn in the ear, and the required antenna dimensions.

### SUMMARY OF THE INVENTION

It is therefore the object of the invention to specify a particularly small antenna for the use in a hearing instrument.

This object is achieved according to the invention by an antenna with the features of the independent antenna claim. This object is further achieved according to the invention by a hearing instrument with the features of the independent hearing instrument claim. Advantageous embodiments or further developments of the invention, some of which are inventive in themselves, are set forth in the dependent claims and the following description.

The antenna according to the invention is configured as a circularly polarized antenna and configured and intended for the use in a hearing instrument. The circularly polarized antenna (hereinafter referred to in short as “antenna”) has a ground layer and an exciter layer separated from the ground layer by a first dielectric layer. The exciter layer is coupled to a signal port routed through the first dielectric layer and the ground layer. In addition, the antenna has a top layer arranged on the side of the exciter layer facing away from the ground layer and separated from the exciter layer by a second dielectric layer. The top layer is connected to the ground layer at four locations by interconnecting a respective capacitance (also: “port capacitance”) and/or a respective inductance (also: “port inductance”).

The ground layer, the exciter layer and the top layer each particularly represent a body, particularly a film-like body, i.e., having a significantly larger (such as by at least 10 times) flat extension (such as diameter or length, width) in comparison to the thickness. Thus, these layers may alternatively also be referred to as (particularly film-like) ground bodies, exciter bodies, and top bodies. The respective dielectric layer is also formed by a body, particularly from a dielectric material or composite material. Its thickness, however, is preferably larger than that of each of the ground layer, the exciter layer, and the top layer. The thicknesses of all layers are particularly dimensioned such that the total thickness of the antenna is smaller than a quarter of an effective wavelength of the antenna:

$${D}_{g} < \frac{{λ}_{eff}}{4} . \qquad ( 1 )$$

In this, the effective wavelength is

$${λ}_{eff} = \frac{{λ}_{0}}{\sqrt{{ϵ}_{r}}} \qquad ( 2 )$$

wherein ϵᵣ is the dielectric constant of the dielectric layers. Ao is the free space wavelength which is about 12 cm with a normal frequency of 2.45 GHZ (wavelength of the Bluetooth radio standard).

Advantageously, the ground layer, when the antenna is used as intended, is connected (coupled) to a ground potential particularly of the hearing instrument.

The arrangement of the ground layer, the exciter layer, and the top layer according to the invention allows for a compact design of the antenna, particularly with respect to its outer dimensions. With respect to its application in mobile devices, particularly in a hearing instrument, this is particularly advantageous. Interconnecting the respective capacitance (preferably in the form of a capacitor, also “port capacitor”) or inductance (preferably in the form of an inductor, also “port inductor”) between the four contacts of the top layer to the ground layer causes the antenna to be circularly polarized. This is also advantageous for mobile applications if the orientation (in the sense of the polarization) of a transmitting antenna towards a receiving antenna is not determined or determinable. A circularly polarized antenna, when coupled to a likewise circularly polarized antenna, is insensitive and in respect to a linearly polarized antenna comparatively insensitive to its orientation of the polarization direction. Linearly polarized antennas, however, have a particularly high dampening to linearly polarized signals, the polarization direction of which does not correspond to its own, particularly being perpendicular to it.

According to a preferred embodiment, a ground via (i.e., a via to the ground layer) is routed through the first and second dielectric layers at each location for contacting the top layer with the ground layer (also in short: contact location of the top layer). The antenna may thus be configured as an integrated component, and contacts located outside in the form of (wire) lines (e.g., cables or the like) may be omitted.

According to another advantageous embodiment, the four contact locations of the top layer (and therefore particularly the four ground vias) are each arranged offset to the respective adjacent contact location by 90 degrees relative to a center (particularly the geometric center) of the top layer. In other words, the ground vias are each located on radials originating from the center of the top layer which are pivoted by 90 degrees relative to one another or are located, with respect to an analog clock, at 12 μm, 3 μm, 6 μm and 9 μm.

Particularly, the contact locations are also arranged at the edge relative to the top layer. “At the edge” is preferably understood herein as the respective contact location being arranged at least within a margin extending around the top layer and having a width of no more than a third of the local distance (i.e., at the location of the contact location) of the outer edge of the top layer to the center of the top layer. Advantageously, the contact locations are also formed to be similar such that the structure of the antenna is (rotationally) symmetric. Particularly, at least a 180 degree, optionally also a 90 degree, rotational symmetry is formed.

In an advantageous manufacturing embodiment, the top layer has a recess located at the edge in the region of each contact location, e.g. in the form of a notch, within which the ground via is in contact with (such as soldered to) the top layer in the plane thereof. Preferably, the respective ground via ends at the contact location.

The exciter layer and the top layer are preferably formed as round discs. The round shape allows for the antenna to be integrated particularly well into the hearing instrument. Basically, the exciter layer and the top layer may also be formed as a polygon, such as a hexagon, octagon or multiples thereof.

According to a preferred embodiment, the diameter of the exciter layer—or its outer dimensions in the case of an uneven shape—is formed smaller than of the top layer. The diameters or outer dimensions of the top layer (except for the optionally present recesses at the contact locations) and of the two dielectric layers further preferably correspond to one another.

According to a preferred further development of this exciter layer having a reduced diameter (surface dimensions), four ground lugs each formed by an annular segment are formed in the plane of the exciter layer and in contact with the ground layer. Particularly, these annular segments have a width of up to half, preferably of about a third or even only of a quarter, of the local edge distance described above of the top layer to the center thereof. These annular segments are galvanically separated from the exciter layer, such as by the first and/or second dielectric layer. Each of these ground lugs advantageously forms an auxiliary capacitor (having a corresponding capacitance) connected in parallel to the capacitance (particularly the capacitor) on the top layer. This is advantageous for the antenna to be circularly polarized. Specifically, having different port capacitances is beneficial for forming a circular polarization. In order to avoid having to employ different port capacitors (i.e., having different port capacitances), the ground lugs advantageously have at least in pairs different circumferential lengths. Preferably, the ground lugs respectively opposite relative to the center (centroid) of the exciter layer are equal in length, and the other two are formed with a different length, e.g., being longer or shorter by up to 1 mm, preferably by about 0.5 mm. However, in order to avoid elliptically polarizing or even linearly polarizing, the difference in length between the ground lugs should not exceed these measurements. This allows for default components to be used as port capacitors. However, optionally required differences may be realized comparatively easily by using the ground lugs.

Advantageously, each of the ground lugs is in contact with a respective one of the four ground vias (and thus with the ground layer). Therefore, an additional contact of the ground lugs with the ground layer is not required, which is beneficial for the compact design of the antenna.

According to an advantageous embodiment, the signal port for the exciter layer is formed by a via (hereinafter referred to as “signal via”). This signal via runs through the first dielectric layer and the ground layer as discussed above. Preferably, the signal via is galvanically decoupled, i.e., electrically isolated, from the ground layer. Furthermore, the signal via is arranged in an angular area between two (adjacent) ground vias, particularly on an angle bisector between two ground vias (meaning preferably pivoted by +/−45 degrees relative to these two ground vias).

Furthermore, the signal port, particularly the signal via, is preferably arranged at the edge (cf. definition above) relative to the exciter layer and joined to it at the edge.

According to a preferred embodiment, the first and second dielectric layers are connected-particularly in the region of a distance surface through between the ground lugs and the exciter layer.

Preferably, the first and second dielectric layers are formed from a material having a relative permittivity of between 5 and 15, particularly of between 8 and 12, preferably of exactly or about (i.e., +/−1) 10. For example, an epoxy resin or a comparable plastic material or a ceramic material is used as such a material.

Advantageously, the ground layer, the exciter layer, the ground lugs and/or the top layer are formed from electrically conductive material, particularly a metal, preferably copper.

Preferably, the outer edge (in the case of a circular top layer) or the respective outer edge (in the case of a polygonal top layer) also represent an outer edge of the entire antenna. Particularly, the first and second dielectric layers are also formed with the same outer diameter or the same outer dimensions as the dielectric layer.

As discussed above, the invention allows for a particularly compact, circularly polarized antenna. Particularly, a largest (outer) diameter—in the case of a circular top layer—(or a largest dimension in the case of an uneven, particularly polygonal top layer) of the top layer and thus preferably also of the antenna is less than or equal to 0.1 times, particularly less than or equal to 0.08 times, preferably 0.06 times, the wavelength of a frequency selected for transmit and receive operations of the antenna. In the case of a frequency being the Bluetooth standard of about 2.4-2.5 GHZ, 0.06 times equals about 0.75 cm. I.e., the invention allows for an antenna having a diameter of less than 0.8 cm for the widely used Bluetooth standard.

The hearing instrument according to the invention has the antenna described above, particularly among at least a microphone, a signal processor, and a loudspeaker. Preferably, the hearing instrument is formed as a hearing instrument to be worn in the ear. Particularly, the hearing instrument forms a hearing aid device.

The conjunction “and/or” is to be understood here and in the following specifically such that the features linked by this conjunction can be formed both jointly and as alternatives to one another.

Other features which are considered as characteristic for the invention are set forth in the appended claims.

Although the invention is illustrated and described herein as embodied in a circularly polarized antenna and a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic perspective view of a hearing instrument;

FIG. 2 is another schematic perspective view of a circularly polarized antenna of the hearing instrument viewed from above;

FIG. 3 is yet another schematic, partially transparent perspective view of the antenna viewed from the bottom;

FIGS. 4, 5 are schematic views of the antenna according to FIG. 2, focusing on an exciter layer and a ground layer, respectively; and

FIG. 6 is a schematic perspective view of electronic components of the hearing instrument in a pre-installation assembly.

Analogous parts are always provided with the same reference symbols in all figures.

### DETAILED DESCRIPTION OF THE INVENTION

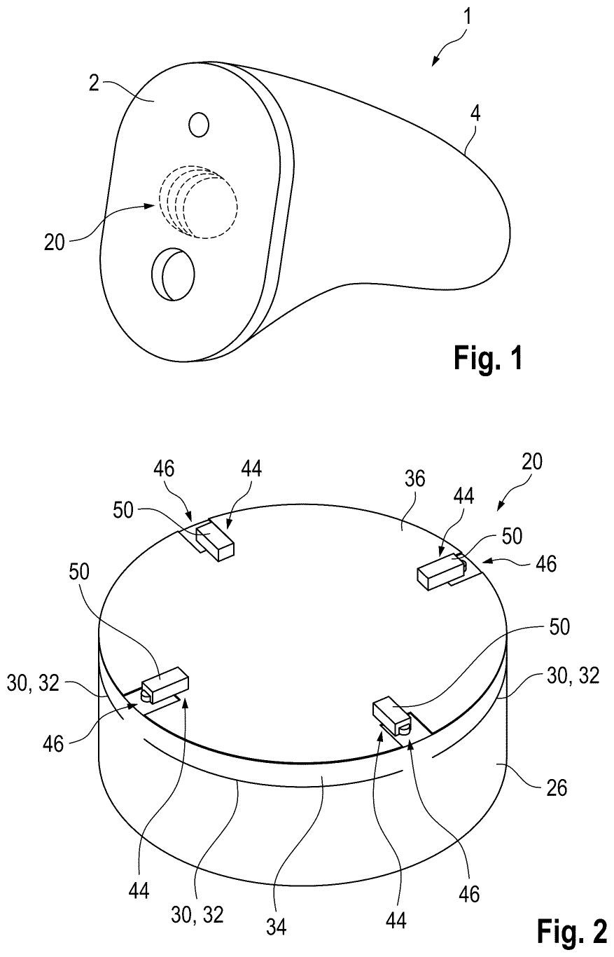

Referring now to the figures of the drawings in detail and first, particularly to FIG. 1 thereof, there is shown a hearing instrument 1 forming a hearing aid device to be worn in the ear. The hearing instrument 1 has a face plate 2 and an ear piece 4 adapted to the ear canal of the ear, both enclosing a housing interior, in which electronic components of the hearing instrument 1 are arranged. The electronic components are formed at least by a microphone 6, a signal processor 8 and a loudspeaker 10 (see FIG. 6). In addition, the electronic components comprise a battery 12 formed as a rechargeable battery, and a battery controller 14 associated with the battery 12, that is configured to provide energy to the other electronic components and to control charging operations. Furthermore, the electronic components comprise an antenna 20 configured and provided for communicating with a mobile device. The antenna 20, the battery controller 14, the microphone 6 and the signal processor are arranged on a folded printed circuit board 22. The battery 12 and the loudspeaker 10 are connected via cables. This results in a pre-installation assembly to be formed, illustrated in FIG. 6.

In the FIGS. 2 to 5, the antenna 20 is explained in more detail. The antenna 20 is radially polarized and has a particularly compact design. In the illustrated embodiment, the antenna 20 is formed in the shape of a circular cylinder.

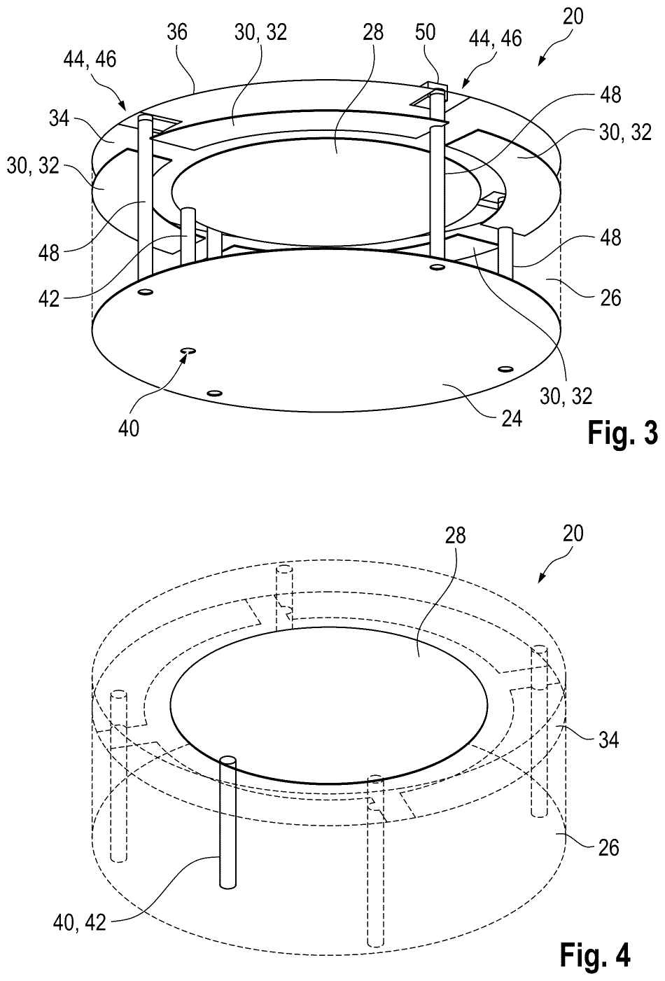

The antenna 20 has a ground layer 24 at the bottom (visible in FIG. 3) which is connected to a ground potential when used as intended (see FIG. 6). A first dielectric layer 26 is arranged on the ground layer 24. The ground layer 24 and the dielectric layer 26 are formed as round discs having the diameter of the circular cylinder of the antenna 20. In the present embodiment, the diameter of the antenna 20 is 6 mm, but may also be in the range from 4 to 8 mm, for example. An exciter layer 28 in the form of a round disc is arranged at the front—opposite the ground layer 24—on the dielectric layer 26. The exciter layer 28 is aligned coaxially to the circularly cylindrical shape of the antenna 20. However, the exciter layer 28 has a smaller diameter than the circular cylinder of the antenna 20. A ring consisting of four annular segments 30 each of which cover a quarter circle is arranged radially outside the exciter layer 28. The radial width of the annular segments 30 is about a quarter to a third of the radius of the circular cylinder. Each of the ring segments 30 forms a ground lug 32. Particularly, any two ground lugs 32 located opposite one another relative to a center of the exciter layer 28 (i.e. its axis) are formed equal in length, and the other two are shorter by 0.5 mm.

A second dielectric layer 34 having in turn the same diameter as the circular cylinder is arranged on the exciter layer 28 and the ground lugs 32—which are arranged in the same plane as the exciter layer 28. A top layer 36 also forming a circular disc is arranged at the front on the second dielectric layer 34 (and thus separated from the exciter layer 28).

The exciter layer 28 is coupled to a signal port 40 which is coupled to a signal line and thus directly to a signal input and output of the hearing instrument 1 when used as intended. The signal port 40 is formed by a via, here referred to as a signal via 42. The signal via 42 runs through (but is galvanically separated from) the ground layer 24 and through the first dielectric layer 26 and is arranged at the edge relative to the exciter layer 28. In the present embodiment, a diameter of the signal via 42 is located within the exciter layer 28, but at an outer edge thereof.

The top layer 36 is connected to the ground layer 24 at four contact locations 44 (see FIG. 2). At each contact location 44, the top layer 36 has a recess located at the edge, specifically a rectangular notch 46, within which a via (“ground via 48”) runs radially outside the exciter layer 28 through the first and second dielectric layers 26 and 34. The notch 46 extends inwards by not more than a third of the radius of the top layer 36. At the bottom, the ground vias 48 are in contact with the ground layer 24. The ground vias 48 are each offset to one another by 90 degrees—relative to a center of the antenna 20 and thus of the top layer 36. The signal via 42 is located on an angle bisector between two ground vias 48.

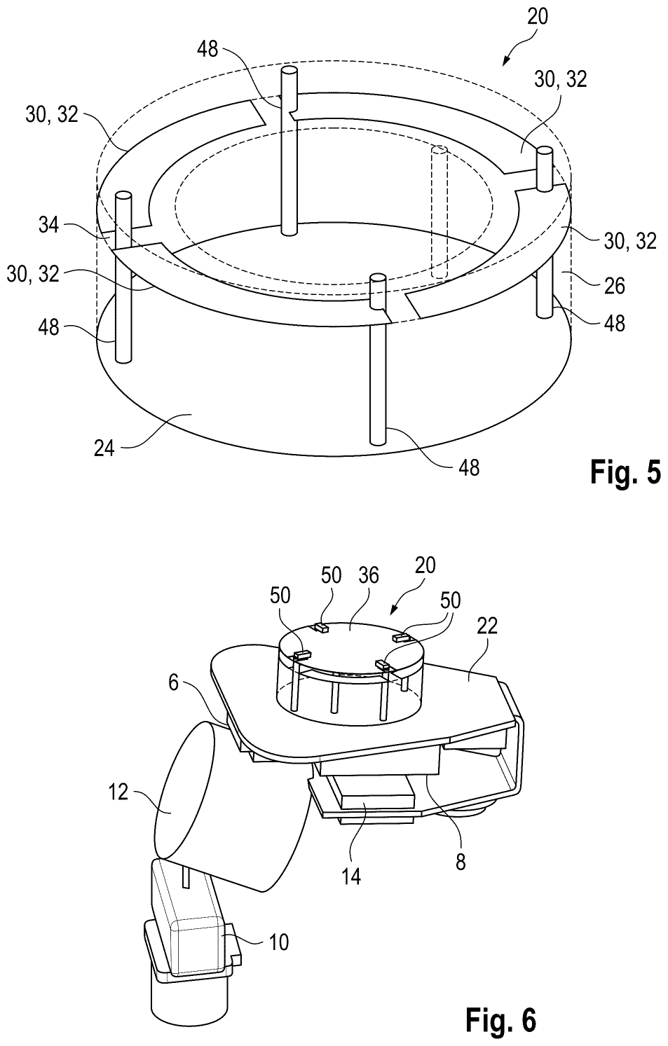

The ground lugs 32 are circumferentially spaced apart and arranged from one another such that the ground vias 48 are routed through between two ground lugs 32. However, a respective one of the ground lugs 32 is in contact with a respective one of the ground vias 48 and thus is in contact with the ground layer 24 (cf. FIG. 5).

The top layer 36 is coupled to the ground vias 48 ending at the contact locations 44 at the front of the second top layer 36 by interconnecting a respective capacitor 50 (having a capacitance). This results in the circularly polarized characteristic of the antenna 20. The ground lugs 32 each form an auxiliary capacitor connected in parallel to the respective capacitor 50. Due to the different lengths of the ground lugs 32 in pairs, the auxiliary capacitors have different capacitances at least in pairs supporting the circularly polarized characteristic of the antenna 20.

The ground layer 24, the ground lugs 32, the exciter layer 28, and the top layer 36 are formed electrically conductive, such as from metal. In the present embodiment, they are each specifically formed by a copper film or copper coating. The first and second dielectric layers 26 and 34 are formed from a material having a relative permittivity of 10+/−1, such as by a plastic material, such as an epoxy resin.

In principle, it is also possible that the ground layer 24 is formed as part of the printed circuit board 22, and thus the antenna 20 is integrated at least partially into the printed circuit board 22.

The subject of the invention is not limited to the embodiment described above. Rather, other embodiments of the invention may be derived from the description above by a person skilled in the art.

The following is a summary list of reference numerals and the corresponding structure used in the above description of the invention:
1 Hearing instrument
2 Face plate
4 Ear piece
6 Microphone
8 Signal processor
10 Loudspeaker
12 Battery
14 Battery controller
20 Antenna
22 Printed circuit board
24 Ground layer
26 Dielectric layer
28 Exciter layer
30 Annular segment
32 Ground lug
34 Dielectric layer
36 Top layer
40 Signal port
42 Signal via
44 Contact location
46 Notch
48 Ground via
50 Capacitor

1. A circularly polarized antenna for a hearing instrument, comprising:
a ground layer;
a first dielectric layer;
a second dielectric layer;
a signal port routed through said first dielectric layer and said ground layer;
an exciter layer separated from said ground layer by said first dielectric layer, and coupled to said signal port; and
a top layer disposed on a side of said exciter layer facing away from said ground layer and separated from said exciter layer by said second dielectric layer, wherein said top layer is connected to said ground layer at four locations by interconnecting a respective capacitance and/or a respective inductance.

2. The circularly polarized antenna according to claim 1, further comprising ground vias, one of said ground vias being routed through said first and second dielectric layers at each of said four location for contacting said top layer with said ground layer.

3. The circularly polarized antenna according to claim 1, wherein said four locations for contacting said top layer with said ground layer are each disposed offset to a respective adjacent location by 90 degrees relative to a center of said top layer.

4. The circularly polarized antenna according to claim 1, wherein said exciter layer and said top layer are formed as round discs.

5. The circularly polarized antenna according to claim 2,
wherein said exciter layer is formed with a smaller diameter than said top layer; and
further comprising four ground lugs each formed by an annular segment are formed in a plane of said exciter layer and in contact with said ground layer.

6. The circularly polarized antenna according to claim 5, wherein each of said ground lugs is in contact with a respective one of said four ground vias.

7. The circularly polarized antenna according to claim 2, wherein said signal port for said exciter layer is formed by a signal via arranged in an angular area between two of said ground vias.

8. The circularly polarized antenna according to claim 7, wherein said signal via is disposed at an edge relative to said exciter layer.

9. The circularly polarized antenna according to claim 1, wherein said first and second dielectric layers are connected.

10. The circularly polarized antenna according to claim 1, wherein said first and second dielectric layers are formed from a material having a relative permittivity of between 5 and 15.

11. The circularly polarized antenna according to claim 1, wherein said ground layer, said exciter layer and/or said top layer are formed from an electrically conductive material.

12. The circularly polarized antenna according to claim 1, wherein a largest diameter of said top layer is smaller than or equal to 0.1 times a wavelength of a frequency selected for transmit and receive operations of the circularly polarized antenna.

13. The circularly polarized antenna according to claim 7, wherein said signal via is arranged in the angular area between two of said ground vias on an angle bisector.

14. The circularly polarized antenna according to claim 1, wherein said first and second dielectric layers are formed from a material having a relative permittivity of between 8 and 12.

15. The circularly polarized antenna according to claim 1, wherein said first and second dielectric layers are formed from a material having a relative permittivity of 10.

16. The circularly polarized antenna according to claim 1, wherein said ground layer, said exciter layer and/or said top layer are formed from a metal.

17. The circularly polarized antenna according to claim 1, wherein said ground layer, said exciter layer and/or said top layer are formed from copper.

18. The circularly polarized antenna according to claim 1, wherein a largest diameter of said top layer is smaller than or equal to 0.08 times a wavelength of a frequency selected for transmit and receive operations of the circularly polarized antenna.

19. A hearing instrument, comprising the circularly polarized antenna according to claim 1.

20. The hearing instrument according to claim 19, wherein the hearing instrument is configured to be worn in an ear.
